(19) United States
(12) Patent Application Publication
(10) Pub. No.: US 2012/0084350 A1
(43) Pub. Date: Apr. 5, 2012

(54) Adaptive distributed medical image viewing and manipulating systems

(76) Inventor: Liang Xie, Birmingham, AL (US)

(21) Appl. No.: 13/200,870

(22) Filed: Oct. 4, 2011

Related U.S. Application Data
(60) Provisional application No. 61/404,569, filed on Oct. 5, 2010.

(51) Int. Cl. G06F 15/16

(52) U.S. Cl. 709/203

(57) ABSTRACT

A pure web browser based medical imaging system that requires no installation of application software or any browser plug-in and functions in the same way as traditional full blown medical imaging PACS (Picture Archiving and Communication Systems) viewer fat clients. In addition, the system intelligently distributes the computing tasks of image rendering between browser and servers from complete server-side rendering to complete client-side rendering and anything between. It comprises a JavaScript medical image rendering library that can process original DICOM (Digital Imaging and Communications in Medicine) data sets and all standard web images at pixel level, a medical imaging server and a rendering load balancing component that can dynamically split the rendering computing from server to client according to their capabilities.

This Patent Application is a Non-provisional Application and claims the Priority Date of a co-pending Provisional Application 61/404,569 filed on Oct. 5, 2010 by common Inventor of this Application. The Disclosures made in the patent application Ser. No. 61/404,569 are hereby incorporated by reference.

### BACKGROUND OF THE INVENTION

1. Field of the Invention

This invention relates generally to system and method for acquiring, storing and distributing medical images. More particularly, this invention is related to systems and methods for adaptively distributing and manipulating medial images.

2. Description of the Prior Art

Radiologists and physicians read, exam and review digitalized medical images for diagnosis and treatment everyday. Patients want to educate themselves about their own image data. The reading, reviewing and self-education happen in hospitals, clinic offices and patient homes, etc. Traditionally, a Medical Image Viewer is a heavy and complicated software application that allows radiologists, physicians, technicians and patients to read local and remote medical images interactively for diagnosis and non-diagnosis purposes. They are called PACS (Picture Archiving and Communication Systems) viewers. Those software applications are installed on dedicated computers as reading workstations, which limits the accessibility to fixed computers. PACS workstations all require software to be installed on certain hardware and operating systems. This is due to three specific characteristics of medical imaging. The first is that the image data volume is large; a multi-slice CT scan can easily generate 100 MB dataset for one study. Secondly the image data itself is sophisticated, for example a CT grayscale image could be in 12-bit while non-medical images are 8-bit. The third is that users often need to interactively manipulate the images for better diagnosis, including zoom, rotate, window/level, sharpen, fusion, histogram, 3D reconstruct, measurement, etc. As a result, medical imaging viewing is constrained to a small set of fixed computers at limited locations to a small group of users.

At the same time, mobile devices are wide spread now. These include Internet tablet, IPad, IPhone, Android phones and many others. To install PACS applications on these mobile devices has been proven hopeless. Users all want to access the full medical imaging freely on any networked device that has a web browser. Sharing of medical image data across different organizations is complicated due to the policy constraint of software installation.

Electronic Medical Record—EMR is being widely deployed. Imaging is a critical part of EMR. However viewing images from EMR always means launching external viewer applications. Big hospitals usually have multiple different PACSs. Physicians often end up launching several different PACS viewers, which interfere with doctors' workflow and productivity. Heavy medical imaging viewer is an outstanding hindering factor to the overall healthcare IT expansion.

There is an urgent need to access fully functioning PACS viewer from a web browser on any device without plug-in or software installation.

On today's market, there are roughly three types of “thin” web clients attempting to meet the above purposes.

The first type is a lite version of a fat client application. In this category, the client is thin in terms of application download size. The software size reduction is achieved by sacrificing advanced viewing features. This still requires download, installation and upgrade. It is still an external application with minimized package size. The second type is with web browser plug-ins including flash, Java, ActiveX etc. Plug-ins are not supported on all devices. For example, IPad does not support flash, Java or ActiveX. Linux/Android devices do not support ActiveX.

The third type is server side rendering. Image rendering happens on servers and the rendered data is sent to browsers for presentation. Any request of presentation changes goes back to server and server generates new data. This has high network bandwidth demand, limited server scalability and sluggish user experience. Interactive pixel manipulation is hard to achieve. There are some clever methods to do pixel level manipulation. But they are all either complicated or fall short of usability since none is direct pixel manipulation in browser without plug-in.

Therefore, for the above and other reasons, there is a need for novel solutions overcoming all the above shortcomings and still providing the same and even more functionalities at much lower cost to hospitals, clinics and patients.

### SUMMARY OF THE PRESENT INVENTION

The Adaptive Distributed Pure Web Browser Based Medical Image Viewer application delivers the same and more functionalities to web browser via pure web page technology without any installation or plug-in, thus making the medical image viewing available from any device anywhere.

In addition, the system intelligently distribute the computing tasks of image rendering between browser and servers from complete server-side rendering to complete client-side rendering dynamically. It comprises a JavaScript image rendering library that can process original DICOM image data at pixel level, medical imaging servers and a rendering load balancing component that can dynamically distribute the rendering computing from server to client according to their capabilities and network bandwidth.

The server rendering engine renders the images to fit the remote client device's display screen resolutions. The JavaScript image rendering library accesses and manipulates images at native pixel level. The rendering load balancer shift the computing tasks from server to client or from client to server based on their performance and network bandwidth.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

The accompanying drawings, which are incorporated in and constitute a part of this specification, illustrate embodiments and together with the description, serve to explain the principles of the methods and systems provided:

FIG. 1 illustrates the architectural components of the Adaptive Distributed Medical Image Viewing and Manipulating Systems;

FIG. 2 illustrates the ubiquitous accessibility of medical imaging on various exemplary networked devices;

FIG. 3 illustrates the list of predefined standard image formats that can be generated by servers and delivered to web browsers for display;

FIG. 4 illustrates the set of storage resolutions for medical images;

FIG. 5 illustrates a typical data flow in the Adaptive Distributed Medical Image Viewing and Manipulating Systems;

FIG. 6 illustrates the case where servers deliver standard web images to browsers for immediate display;

FIG. 7 illustrates servers deliver original DICOM pixel data to browsers and the JavaScripts render them locally in browsers;

FIG. 8 illustrates users interactively manipulate images locally without communicating with servers;

FIG. 9 illustrates users interactively perform a variety of measurements locally without communicating with servers;

FIG. 10 illustrates the list of actions provided by the JavaScripts library.

### DETAILED DESCRIPTION OF THE PREFERRED EMBODIMENT

This invention discloses a pure web browser based architecture, delivering full PACS workstation to any networked devices with web browsers. These include but are not limited to PC, Mac, Linux/Unix, Tablet, PDA and smart phones. FIG. 2 illustrates the ubiquitous accessibility of medical imaging on various exemplary networked devices. There will be no need for any software installation or any web browser plugins. The only necessary software is modern web browsers. The Adaptive Medical Imaging Server dynamically balances the computing tasks between servers and client to achieve best possible user experience.

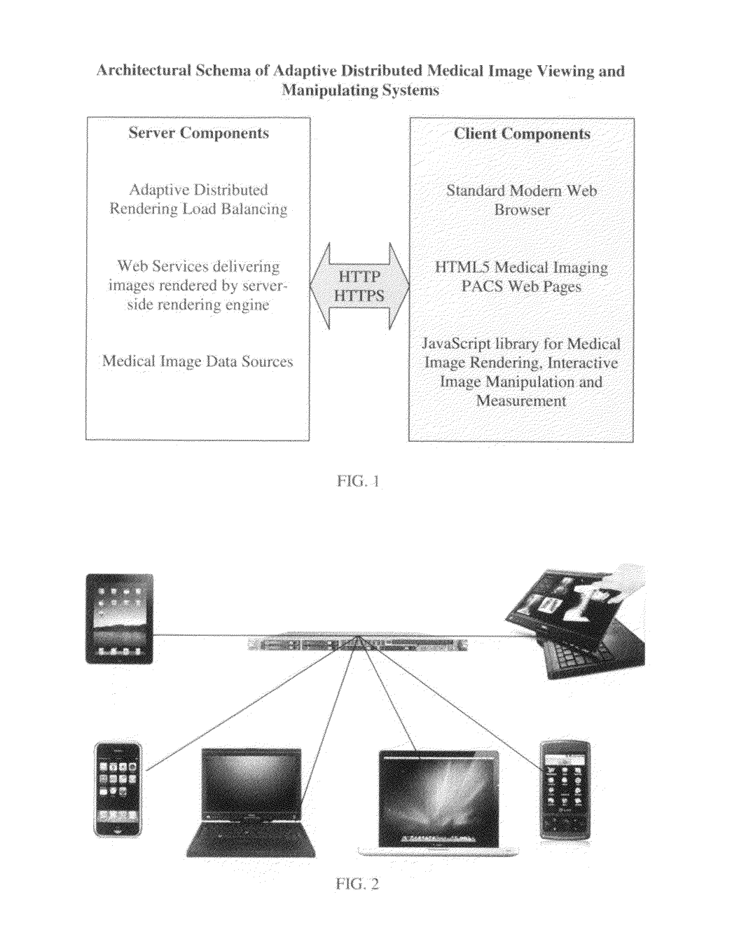

This architecture is based on the cutting-edge cloud computing and Rich Internet Application paradigm. Cloud computing medical imaging servers provide image data and image rendering web services to clients on demand controlled by the server-client load balancing. The medical viewing Rich Internet Application only assumes the existence of a modern web browser, and uses JavaScript to release the power of browser's rendering engine, thus requiring zero plugin with the native performance. FIG. 1 illustrates the architectural server-client components of the Adaptive Distributed Medical Image Viewing and Manipulating Systems.

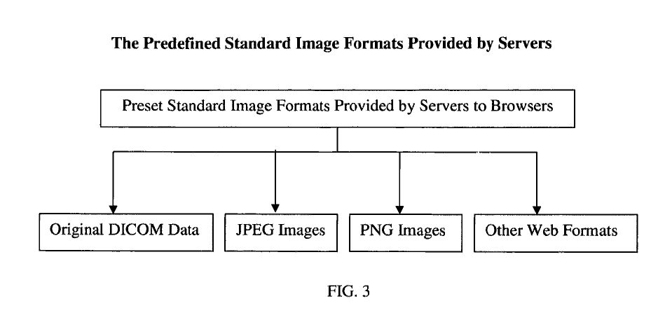

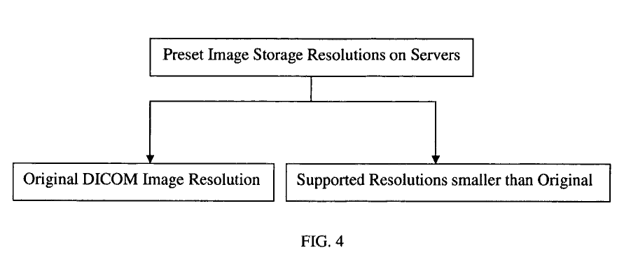

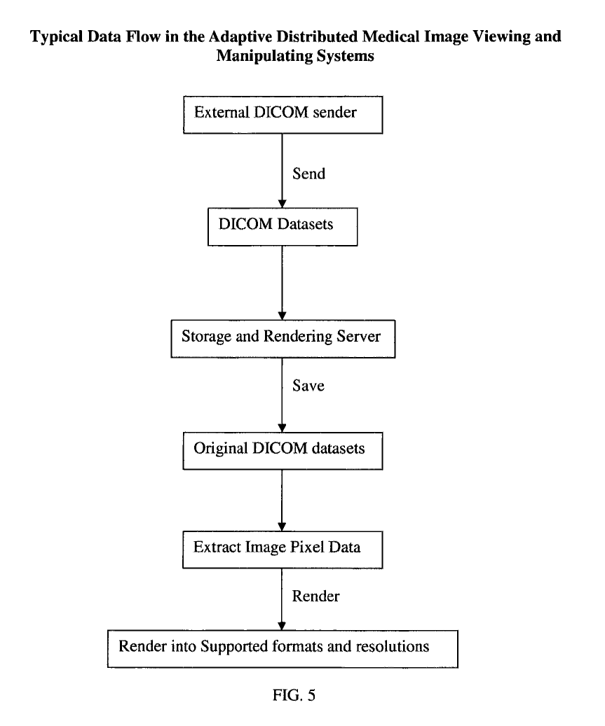

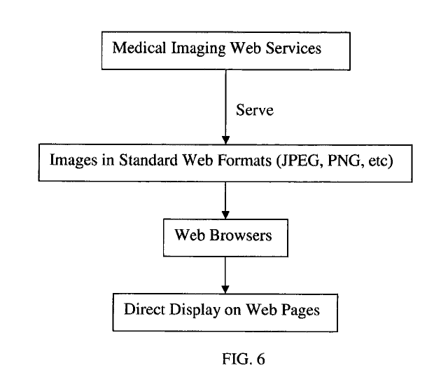

The server-side rendering is responsible for generating a set of Internet-standard-format images of different resolutions/sizes. FIG. 4 illustrates the set of storage resolutions for medical images. The generated images are ready to display in any modern web browsers. The image formats include but are not limited to GIF, JPEG, PNG, lossy and lossless. FIG. 3 illustrates the list of predefined standard image formats that can be generated by servers and delivered to web browsers for display. The rendering operation occurs when the DICOM image datasets first arrive into the system or when user clients request them. When the images are served to the clients, the servers pick the best matching resolution/size with the client display screen and send the chosen images to clients. FIG. 6 illustrates the case where servers deliver standard web images to browsers for immediate display. The pre-defined rendered image sizes include original DICOM image size—w pixel by h pixel, and a set of smaller sizes that match different type of devices' displays: 2048×2560 pixels, 1680×1050 pixels, 1024×768 pixels, 960×640 pixels, 854×480 pixels, 480×320 pixels with the maximum size generated being the size of the original DICOM image. FIG. 5 illustrates a typical data flow in the Adaptive Distributed Medical Image Viewing and Manipulating Systems.

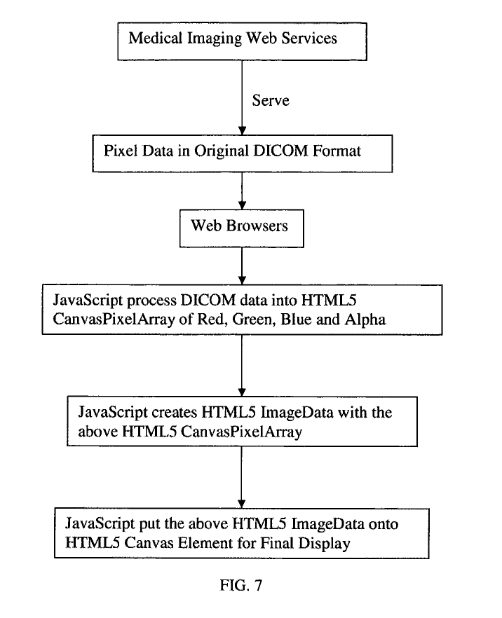

The cloud computing of PACS is responsible for delivering the un-rendered original DICOM pixel data to client as streams when requested. FIG. 7 illustrates servers deliver original DICOM pixel data to browsers and the JavaScripts render them locally in browsers. This facilitates the diagnostic full-fidelity medical imaging on the PACS workstation within web browsers.

The server also accepts and stores images that are rendered by a client and sent by the client to the server for the purpose of reuse either by other clients or at a later time by the same client.

The load balancing component comprises server rendering response time monitor, server network outbound traffic throughput monitor, client rendering speed data collector, client download network speed data collector. For rendering, the measurement equation is the size of generated frame buffer divided by the time elapse of the rendering. For network, the speed of the amount of bytes transferred divided by the time taken.

The load balancing component compares and gets the minimum between the speed of server outbound network and the client network download. The minimum speed is recorded as the transfer speed from a server to a particular client. The time T taken for a user to have eyes on an image with the size of N bytes is calculated as the following: T={(N×S)/((speed of server rendering)+(speed of transfer to the client))}+{(N×(1−S))/((speed of client rendering) +(speed of transfer to the client))}, wherein S is the load percent to be performed by the server. The load balancing component varies the value of S from 0 to 1 and selects the values that yields the minimum T.

The load balancing component constantly monitors, calculates, predicts and adjusts the optimal S value to redistribute the computing tasks between servers and clients. Users are always given the option to configure and overwrite the S value for her/his particular client devices.

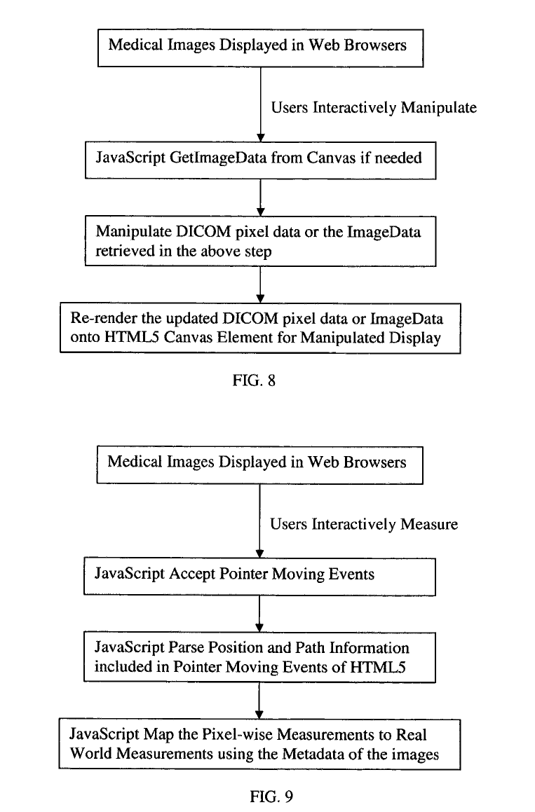

The pure web browser based client side rendering provides the functionalities of a traditional PACS workstation at the native level with zero plugin or software installation. This is achieved by using JavaScript API (Application Programming Interface) to directly update bitmap in HTML5 canvas element. The JavaScript library implements the complete DICOM rendering pipeline by means of a list of actions. The actions are DICOM raw pixel data preprocessing, Crop, Window/Level adjustment, Invert, Zoom, Rotate, Filter, Noise Adding/Reduction, Edge Detection, Fusion and others. All of these actions happen inside the client web browser. FIG. 8 illustrates users interactively manipulate images locally without communicating with servers.

In addition to the rendering and pixel manipulation functions, the JavaScript library is responsible of client side line measurement, angle measurement, histogram, pixel value probe, annotation, hanging protocol management and study presentation creation. FIG. 9 illustrates users interactively perform a variety of measurements locally without communicating with servers.

The JavaScript client allows users to store what users see to the server as web standard images, providing a mechanism for users to share their view.

The JavaScript client allows users to read DICOM datasets that locally reside on users' client machine without any server side communication.

The pure web browser based medical imaging client is responsible of pre-loading data from server in the background, without blocking users' operations.

The medical imaging client retrieves medical image not only from the server it launches against but also from other permitted servers, thus enabling the reading of medical images on multiple server different sources.

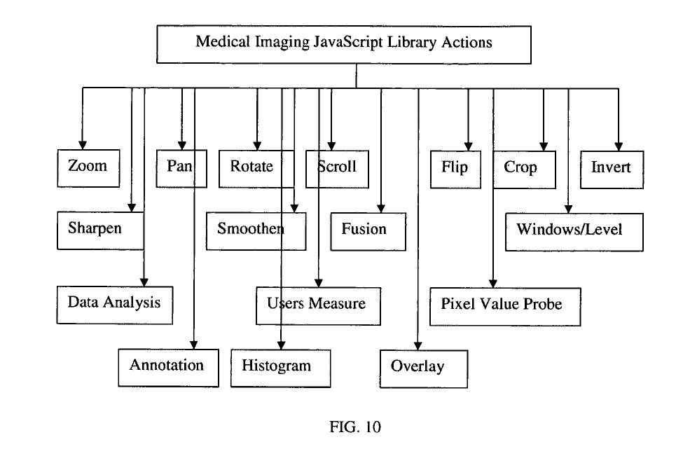

The JavaScript library has separate files for each action. FIG. 10 illustrates the list of actions provided by the JavaScripts library. The client side loads the individual JavaScript files on demand.

The medical imaging client functions are accessible through a standard URI (Uniform Resource Identifier) by any external applications or web sites. Examples for the patterns of the URI are (but not limited to) http://{server}/{command}/{objectID} and https://{server}/{command}/{objectID}, wherein {server} is the server host/ip and port, {command} could be “query”, “view”, “save”, “update”, “delete”, etc, the {objectid} is used to identify an object or a list of objects. Therefore, integration with other systems such as EMR (Electronic Medical Record), PHR (Personal Health Record) is “one-line” step. The networking protocol between servers and clients are standard HTTP and HTTPS, which further simplify the integration.

The pure browser-based medical imaging client is fully available as offline web application. When there is no network connection, users can continue their work on data that's already cached on local machines. Once the network connection comes back, the client automatically saves updates (if any) to servers and refreshes updates (if any) from servers. By doing the above, this method provides smooth user experience even when the network gets interrupted periodically.

The pure browser-based medical imaging client can detect the location of the device from which a user is accessing the system. The client can communicate user's location across the system with the permission of the user.

The pure browser-based medical imaging client runs inside a modern web browser over wired, wireless, cellular and satellite network on any computers, smart phones, browser- enabled TV, thus delivering the mission-critical PACS ubiquitously at no additional cost to healthcare infrastructure and users.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A pure web browser based medical imaging system, comprises a JavaScript image rendering library that can process original raw DICOM (Digital Imaging and Communications in Medicine) image data at pixel level inside web browser, medical image rendering servers that provide server-side rendering for the client and rendering load balancing components that can dynamically distribute the rendering computing task between servers and client according to their capabilities and network bandwidth.

2. The system of claim 1, wherein the servers comprise server-side full PACS image rendering.

3. The system of claim 1, wherein the server-side rendering engine generates standard format images that are ready to display in web browsers.

4. The system of claim 1, wherein the server-side rendering engine generates standard format images with resolutions and sizes matching the display resolutions and sizes of client devices.

5. The system of claim 1, wherein the servers deliver ready-to-display image data to web browsers when needed.

6. The system of claim 1, wherein the servers deliver original raw DICOM image data to web browsers when needed.

7. The system of claim 1, wherein the servers deliver metadata of the original DICOM image data to web browsers for the JavaScript image rendering library to interpret the raw image data when needed.

8. The system of claim 1, wherein the medical imaging servers adaptively deliver the minimum sufficient amount of data that matches the display of client devices.

9. The system of claim 1 further comprises web services with REST (REpresentation State Transfer) style URL to present image rendering in web browsers, allowing one-line integration by any systems.

10. The system of claim 1, wherein the rendering load balancing monitors the computing load of the server and client machines.

11. The system of claim 1, wherein the rendering load balancing monitors the network bandwidth and load between the servers and client machines.

12. The system of claim 1, wherein the rendering load balancing adaptively distributes and re-distributes the percentage of rendering tasks among the servers and client machines.

13. The system of claim 1, wherein the rendering load balancing adaptively distributes the rendering computing tasks to achieve maximum performance perceived by users, based on the servers, clients computing load and network bandwidth.

14. A method comprising image rendering, manipulations and measurements via JavaScript in web browser.

15. The method of claim 14, wherein the individual JavaScript files are loaded by client on demand as needed.

16. The method of claim 14 further comprises methods rendering any original DICOM image data directly onto canvas element of html5 as 2D images.

17. The method of claim 14 further comprises methods rendering any original DICOM image data directly onto canvas element of html5 as 3D images.

18. The method of claim 14, wherein the rendering library processes image data sent from server and/or image data residing locally on client's machines.

19. The method of claim 14, wherein users are provided with multiple viewing widows for multiple DICOM image series.

20. The method of claim 14, wherein users are allowed to configure hanging protocols in web browser.
